(19) United States
(12) Patent Application Publication
(10) Pub. No.: US 2026/0180489 A1
(43) Pub. Date: Jun. 25, 2026

(54) ULTRA-LIGHTWEIGHT ALUMINUM SOLAR POWER SUPPLY TRAILER WITH FOLDWAY FLEXIBLE SOLAR PANELS ON SLIDING TRAYS

(71) Applicant: Richard Martin Clewis, Odessa, FL (US)

(72) Inventor: Richard Martin Clewis, Odessa, FL (US)

(21) Appl. No.: 19/000,156

(22) Filed: Dec. 23, 2024

(51) Int. Cl. H02S 10/40; H02S 10/20; H02S 20/30; H02S 30/20; H02S 40/42

(52) U.S. Cl. CPC H02S 10/40; H02S 10/20; H02S 20/30; H02S 30/20; H02S 40/425

(57) ABSTRACT

A trailer configured to collect solar energy from a plurality of solar panels connected to an electrical system. Central, forward, and aft pluralities of solar panel trays deploy from the trailer to support arrays of solar panels that charge batteries connected to the electrical system. The forward and aft pluralities of trays slide away from a central portion of the trailer and unfold to support solar panels on the right and left side of the trailer as well as in front of and behind the trailer. A plurality of 400 Watt 90 charging modules combined for a total direct current array power of 8.4 KW, wherein the output from each charging module is connected to a separate DC optimizer. The electrical system includes at least one 240 V @25 amp AC output connector, a 120 V @25 amp AC output connector, and a 12 V @30 amp DC output connector.

### FIELD OF THE INVENTION

The present invention relates broadly to using solar panels for charging batteries. Specifically, the present invention relates to a deployable trailer for supporting solar panels.

### BACKGROUND OF THE INVENTION

Solar energy has become an increasingly important power source in recent decades and now has become an affordable and effective technology for generating electricity. With the advent of relatively low-cost, durable solar panels, multiple solar panels are configured on vehicles and sometimes trailers to harvest energy. However, vehicles typically lack sufficient horizontal surface areas for mounting solar panels, and traveling at high speeds means vibration and wind resistance significantly shorten the lifespan of mounted solar panels. Existing trailers that carry mounted solar panels suffer the same shortcomings of limited surface area and exposure to wind resistance and vibration. Existing solar trailers on the market and in patents are too heavy to be of use to be used as an electric range extender due to the range hit caused by the extra weight. Also, they are not powerful enough to get the energy and therefore miles needed.

### SUMMARY OF THE INVENTION

The present invention solves the problems facing existing solar panel vehicular deployment configurations by presenting an ultra-lightweight trailer that, once parked, unfolds an arrangement of support members to present a usable surface area of numerous solar panels that is significantly larger than the horizontal surface area of the trailer itself, and connects the solar panels to single charging system. During transport, the support members fold and slide into a compact configuration on the trailer and the solar panels are safely stored, protected from wind and vibration while the trailer is moving. In one of many contemplated applications of the present invention, an electric vehicle tows the trailer, and, when parked, is recharged through its electrical connection to the solar panel array supported by the unfolded trays of the trailer of the present invention. The present invention can also be used for other power supply needs in the military, emergency response, in remote areas, camping and overlanding. The key to the present invention is the use of high-powered, flexible solar panels which are at a fifth of the weight of the traditional glass and metal frame versions. Combined with a unique stowage and folding system that requires minimum bracing, the total weight is around 1200 pounds yet the system is rated at 8.4 KW with 10 KW hours of onboard power storage.

### Operation

Three pluralities of photovoltaic (PV) module trays (forward, aft, and central) holding seven solar panels each stack into one space because the top tray slides six feet forward and the bottom tray slides out from each tray. Each tray has a folding frame with support legs on the outermost sides of the tray. Each folding frame holds three solar panels, one affixed securely to the folding frame and two that fold onto that for storage but are themselves deployed and supported by telescoping lateral support legs.

Once the 21 solar panels (400 watts each) are unfolded into a sunny area and supported, they pass DC energy along to optimizers that allow each module to collect energy even if the other modules are shaded or oriented to less effective positions. DC energy is stored in a lightweight 10 KWh lithium iron phosphate battery bank by the inverter/charger that also provides 120 volt and 240 volt power outlets at 6000 watts continuous rating. A level 2 car charger can be plugged into the 50 amp receptacle onboard to provide EV car battery charging. The batteries can also be charged separately by plugging the system into a 240V receptable via an optional charging cable if desired. As solar energy fills the battery banks, it is possible to charge the stationary car's battery as well. Modest amounts of on-board energy are required since most EV batteries of larger capacity and can store the large amount of energy provided by the 8.4 KW system.

A typical sunny day can provide up to 50 KWh of energy which is about 150 miles of range for a typical electric car. Lightweight components and modules allow such a large array and keep the total trailer weight under 1200 pounds, feasible for even small EV cars to tow and light enough not to incur a high range penalty. The trays allow for a low profile and low co-efficient of drag, since the modules fold up and slide up into a 6 by 4 foot space that is only 4 feet off the ground at its greatest height. Once the onboard batteries are charged and the EV battery is charged to desired capacity, the 21 modules can be folded up by one average-sized adult. A cover is placed around the module stack for protection during travel. In most cases the trailer will be left on the vehicle while in the sunny location to prevent movement. Optional brakes and wheel locks can allow the trailer to be left away from a vehicle securely.

### BRIEF DESCRIPTION OF THE DRAWINGS

FIG. 1 shows a schematic diagram of the electrical system of the preferred embodiment of the present invention.

FIG. 2 shows the trailer in a retracted, folded configuration.

FIG. 3 shows the slide-out aft tray and slide-out forward tray unfolded laterally with legs that extend from the slide-out trays to the ground.

FIG. 4 shows the right side of the trailer supporting an array of nine solar panels.

FIGS. 5 and 6 show the trailer with solar panels in a folded and retracted configuration, ready for towing.

FIG. 7 shows the electrical system contained in a weatherproof compartment on the tongue of the trailer.

FIGS. 8 and 9 show an alternative embodiment of the present invention that is attached to the top of a pop-up camper trailer.

FIG. 10 shows an actuator used with the embodiment of present invention shown in FIGS. 8 and 9.

### DETAILED DESCRIPTION OF THE INVENTION

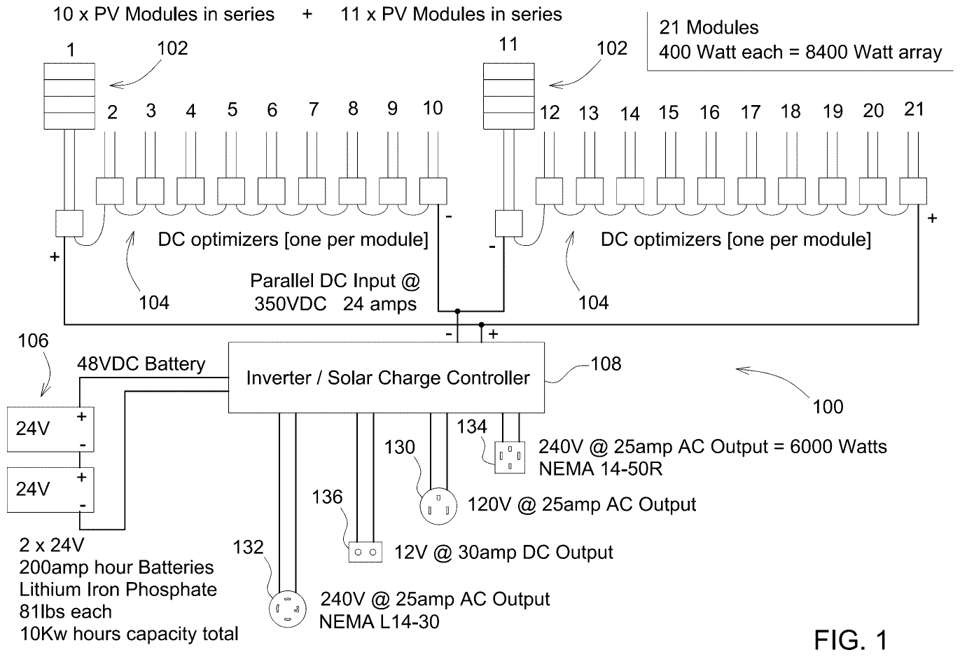

FIG. 1 presents a schematic diagram of the electrical system 100 of the preferred embodiment of the present invention. As shown, there are 21 charging modules 102 at 400 watts each. Modules 102 combine for a total direct current (DC) array power of 8.4 KW. The output from each module 102 is connected to DC optimizer 104, which allows each module 102 to operate independently of the other modules as there may be unequal power harvesting rates when individual solar panels experience different levels of shade and variations in orientation with respect to the sun. Thus, the independent operation of each module 102 allows for greater energy harvest as each module is producing electricity at its individual maximum rate without being affected by the other modules. Wiring methods are employed on the array to allow for the trays of solar panels to slide up and down, respectively, while protecting the photovoltaic (PV) wires connecting each solar panel to its connected DC optimizer 104. An outdoor rated battery set 106 is used to provide a lightweight yet powerful storage solution onboard the trailer. However, the main goal of the present invention is to charge an electric vehicle motive battery which typically has multiple times the capacity of the 10 KWh battery set 106. Inverter 108, utilized by the system has multiple outputs, allows for a split phase 120 Vac output 130 along with 240 Vac outputs 132 and 134 and 12V DC output 136 is added stepped via a converter down from battery 106. Inverter 108 has also been from that 12 Vdc line actively cooled with two pulse width modulation cooling fans inside water resistant electrical system enclosure 110 to provide a cooled environment for inverter 108 during operation. In addition to the photovoltaic (PV) power source, there is a 240V AC input (not shown) provided for charging the battery or even passing power through the unit like a universal power source (UPS), if connected to an external power source.

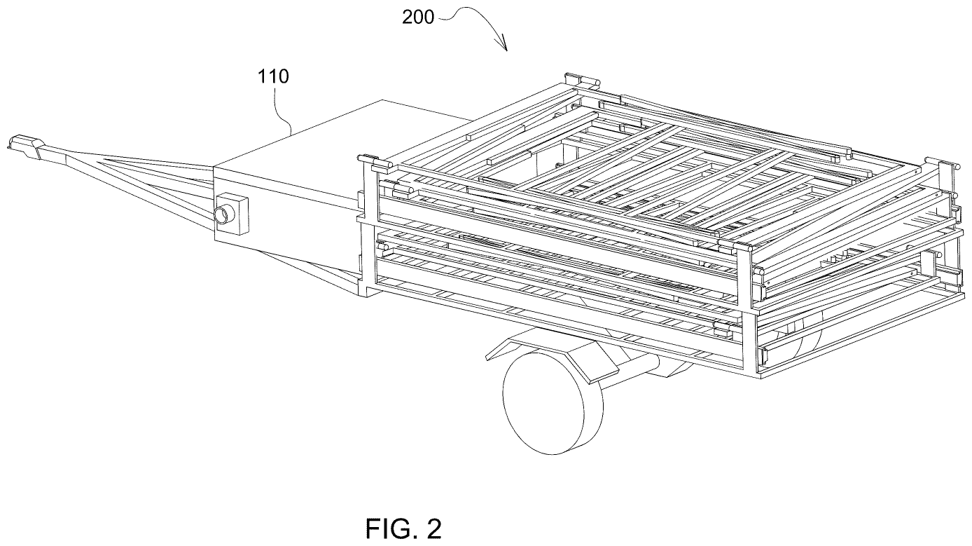

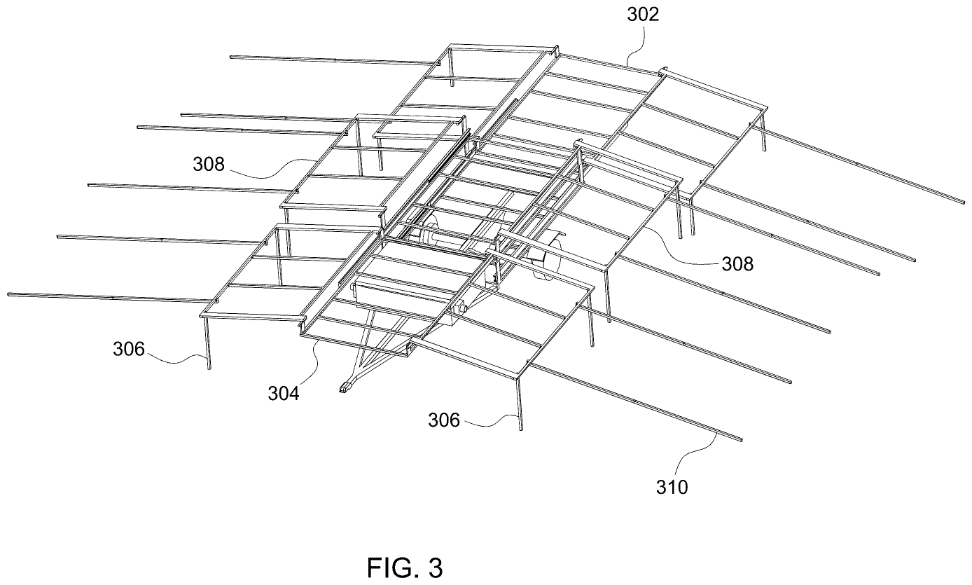

Directing attention to FIG. 2 and FIG. 3, FIG. 2 shows trailer 200 in a retracted, folded configuration (without solar panels for clarity). As shown in FIG. 3, slide-out aft tray 302 and slide-out forward tray 304 extend longitudinally from the central portion of trailer 200, as shown in FIG. 3. Also, as shown in FIG. 3, slide-out aft tray 302 and slide-out forward tray 304 unfold laterally with legs 306 that extend from slide-out trays 302 and 304 to the ground, providing support for solar panels that rest on top of them. Similarly, the central tray portion of trailer 200 unfolds laterally to present solar panel support trays 308 also supported by legs extending to the ground.

Additional lateral legs 310 extend from the outermost edges of unfolded trays on left and right sides of trailer 200 to Slide-out forward tray 302 and aft tray 304, and central trays 308 with their unfolded legs, support arrays of solar panels in an energy-harvesting application. Individual solar panels in the array are tightly grouped to form a nearly completely covered surface area of solar panels.

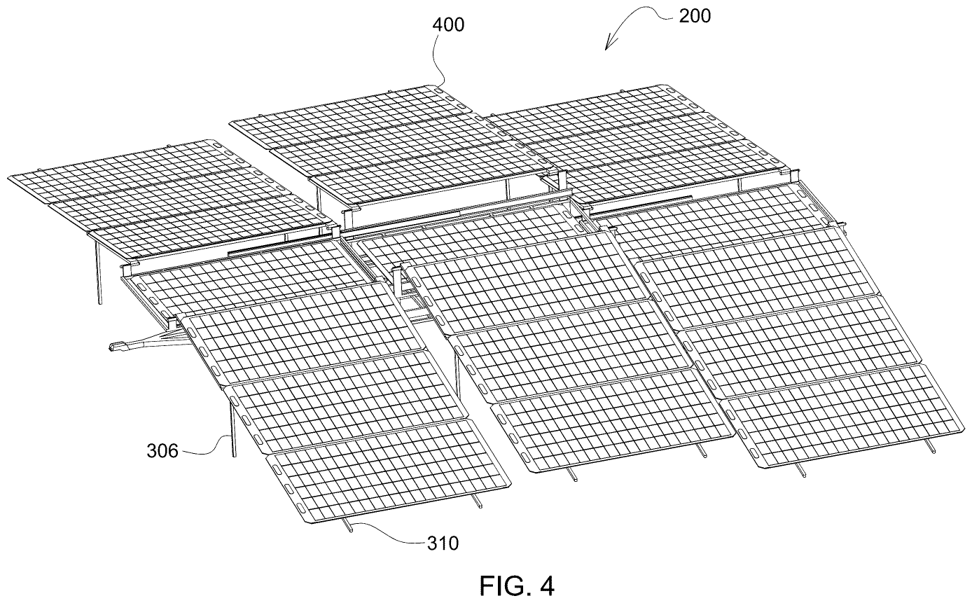

As shown in FIG. 4, the right side of trailer 200 supports an array of nine solar panels 400. An equal number of solar panels are presented in a similar arrangement and are supported on the left side of the trailer (not shown). The central tray of trailer 200, extending longitudinally along the center of trailer 200 across the forward and aft portions supports three more solar panels, for a total array of 21 solar panels.

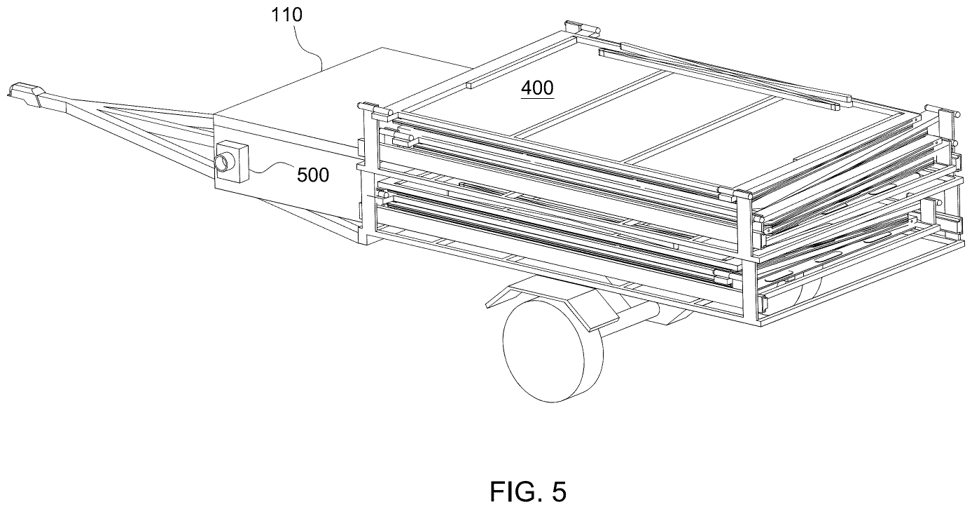

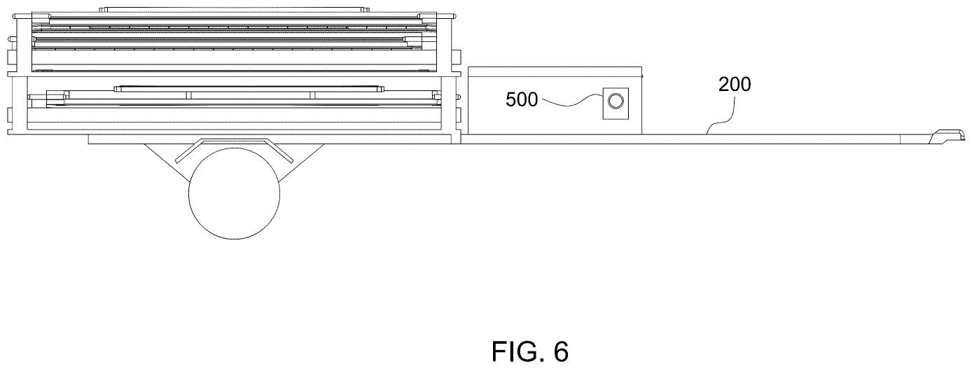

FIG. 5 and FIG. 6 show trailer 200 with solar panels 400 in a folded and retracted configuration, ready for towing. Also shown are cooling fans 500 installed on the sides of electrical system enclosure 110.

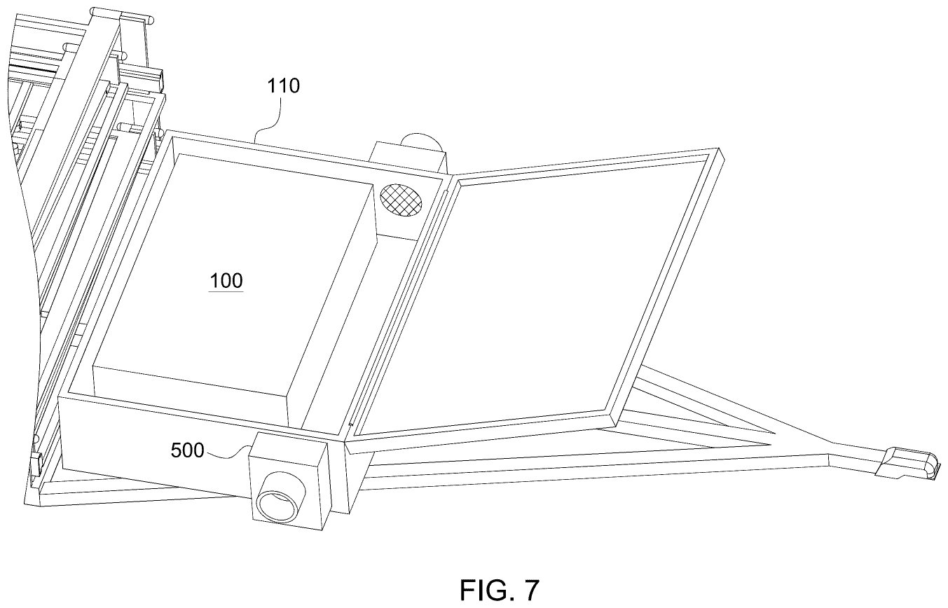

FIG. 7 shows electrical system 100 illustrated as a block for simplicity and described above with respect to FIG. 1, contained in weatherproof enclosure 110 on tongue 700 of trailer 20.

Numerous modifications can be made to embodiments of the present invention which are not shown in FIGS. 1-7. For example, a cover can be placed over the trailer for transport. A spare tire can be mounted on the trailer. The dimensions of various components can be modified to accommodate more solar panels.

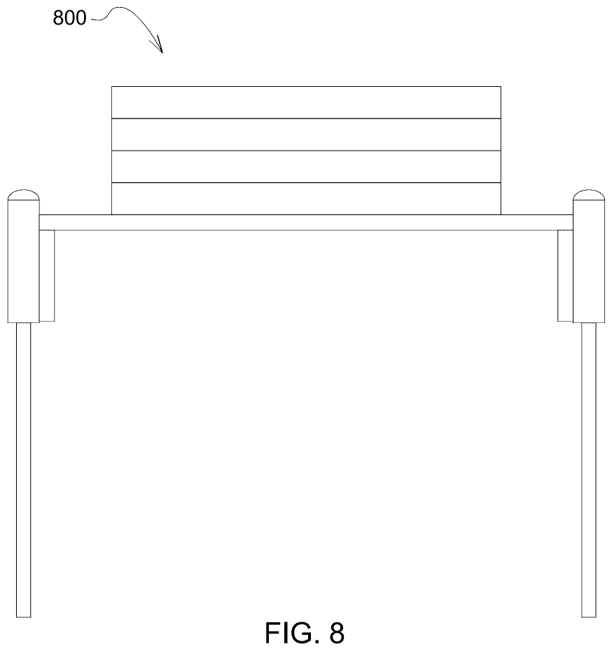

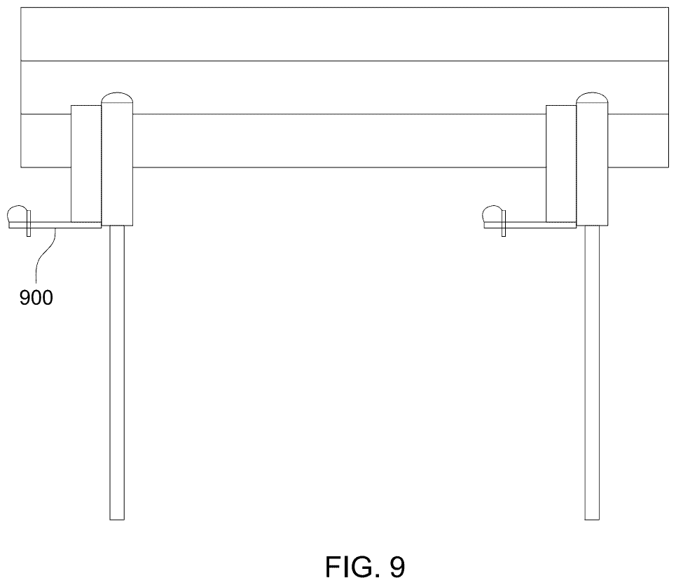

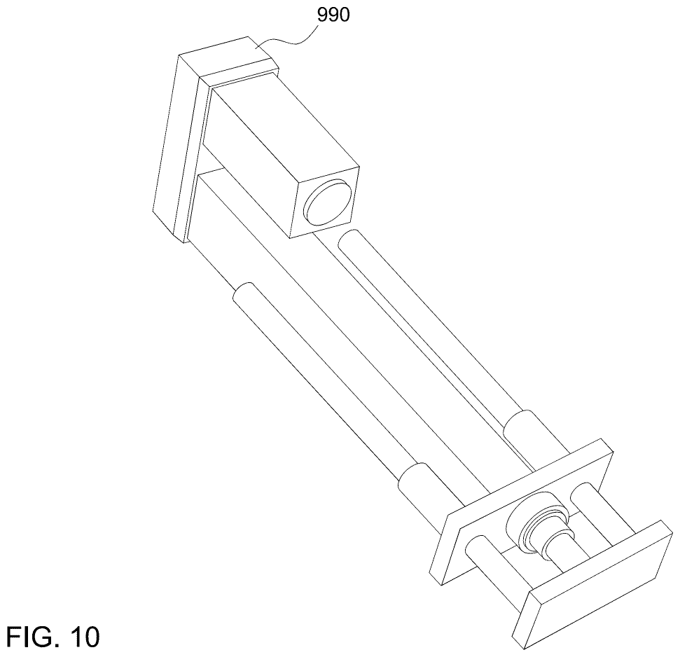

Another embodiment, shown in FIGS. 8-10, implements the present invention on top of a pop-up camper trailer (not shown) as system 800. This embodiment can be towed behind an electric vehicle with moderate towing ability and provide an off-grid living and moving system. This design separates the back of the pop-up camper trailer with the solar panels from the front with the batteries and electrical components. The solar section is light enough to rise on the four actuator legs powered by actuator 990 (FIG. 10) and ride on top of the camper. The pop-up camper trailer utilizes a surface 900 (FIG. 9) for the legs to rest on and lock in. The batteries and electrical system enclosure are mounted on the pop-up camper trailer tongue as described above in the preferred embodiment.

In an unshown embodiment, the operational concept of the present invention can be implemented as a larger-scale application on a flatbed trailer used with 18-wheeler big rig trucks. Such trailers can be as long as 40 feet, and in some cases multiple trailers can be linked together and pulled by a single truck. Such applications would be especially useful for military or disaster-relief applications, where entire solar farms can be easily transported and deployed at a desired location. Rather than using the slide out trays of FIGS. 1-9, the solar panels can simply be unfolded from the flatbed trailers on the right and left sides of the vehicle and utilize longer support arms with vertical supports to allow larger numbers of solar panels to be used in the same manner as shown in FIGS. 1-9.

1. A trailer configured to be towed by a vehicle, comprising:
an electrical system configured to collect solar energy from a plurality of solar panels connected to the electrical system;
a central plurality of solar panel trays;
a forward plurality of solar panel trays configured to slide forward from a stored position in a vertical relationship with the central plurality of solar panel trays to a deployed position in a forward, adjacent position with respect to the central plurality of solar panel trays;
an aft plurality of solar panel trays configured to slide in a rear direction from a stored position in a vertical relationship with the central plurality of solar panel trays to a deployed position in an aft, adjacent position with respect to the central plurality of solar panel trays;
wherein the central plurality of solar panel trays includes lateral trays configured to unfold from a stored position to a deployed position, each lateral tray having pair of vertical legs configured to support the lateral tray and a pair of lateral legs extending in a lateral direction from an outermost edge of the lateral tray, the pair of lateral legs having sufficient length to support additional solar panels;
wherein the forward plurality of solar panel trays includes lateral trays configured to unfold from a stored position to a deployed position, each lateral tray having pair of vertical legs configured to support the lateral tray and a pair of lateral legs extending in a lateral direction from an outermost edge of the lateral tray, the pair of lateral legs having sufficient length to support additional solar panels; and
wherein the aft plurality of solar panel trays includes lateral trays configured to unfold from a stored position to a deployed position, each lateral tray having pair of vertical legs configured to support the lateral tray and a pair of lateral legs extending in a lateral direction from an outermost edge of the lateral tray, the pair of lateral legs having sufficient length to support additional solar panels.

2. The trailer of claim 1, wherein the trailer includes a forward portion on which the electrical system is located and connected to solar panels supported by the central, forward, and aft pluralities of solar panel trays.

3. The trailer of claim 1, wherein the electrical system comprises a plurality of 400 Watt charging modules combined for a total direct current array power of 8.4 KW, wherein the output from each charging module is connected to a separate DC optimizer.

4. The trailer of claim 1, wherein the electrical system includes at least one 240V @25 amp AC output connector, a 120V @25 amp AC output connector, and a 12V @30 amp DC output connector.

5. The trailer of claim 1, wherein the electrical system is housed in an enclosure having a plurality of cooling fans.

6. The trailer of claim 1, wherein the electrical system includes a battery set of two 24V, 200 amp hour batteries charged by solar energy collected from solar panels supported by the central, forward and aft pluralities of solar panel trays.
